(19) United States
(12) Patent Application Publication
(10) Pub. No.: US 2025/0225594 A1
(43) Pub. Date: Jul. 10, 2025

(54) GENERATING RISK ANALYSIS REPORTS USING A RISK MODEL

(71) Applicant: Schlumberger Technology Corporation, Sugar Land, TX (US)

(72) Inventors: Pierre Sesboue, Montpellier (FR); Valerian Guillot, Montpellier (FR); Mohamed Khalil Nafi, Benghazi (LY); Ahmed Abdelfattah El Ganaini, Dubai (AE); Todd Hughes, Dhahran (SA); Mohamed Yehya Rabie, Kuala Lumpur (MY); Christophe Douy, Montpellier (FR); Davy Azoulay, Montpellier (FR); Samuel Rochette, Montpellier (FR); Kevin Anoll, Montpellier (FR)

(21) Appl. No.: 19/013,197

(22) Filed: Jan. 8, 2025

Related U.S. Application Data
(60) Provisional application No. 63/618,453, filed on Jan. 8, 2024.

(51) Int. Cl. G06Q 50/02; G06F 3/04817; G06F 3/0484; G06Q 10/0635

(52) U.S. Cl. CPC G06Q 50/02; G06Q 10/0635; G06F 3/04817; G06F 3/0484

(57) ABSTRACT

A drilling risk analysis system may provide, on a graphical user interface (GUI) of a computing device, a selectable work icon associated with a modular work item of a wellbore plan. Based on receiving a work icon selection of the selectable work icon, the drilling risk analysis system may provide, on the GUI, a selectable event icon associated with historical events related to the modular work item associated with the selectable work icon. The drilling risk analysis system may, based on receiving an event icon selection of the selectable event icon, apply a risk model to the modular work item. The risk model performs a risk analysis of an event likelihood and event severity of an event related to the historical events and generates a risk analysis report of the event. The drilling risk analysis system may present the risk analysis report of the event on the GUI.

This patent application claims priority to U.S. Provisional Patent Application No. 63/618,453, filed on Jan. 8, 2024, which is incorporated by reference.

### BACKGROUND OF THE DISCLOSURE

Drilling planning includes the generating of wellbore plans for drilling a wellbore. The wellbore plans include projected equipment, drilling parameters, wellbore trajectory, wellbore depth, formation information, and other wellbore plan information. In some situations, a drilling planner may generate risk analyses of the risks associated with events that may occur during drilling of the wellbore. Typically, a risk analysis may be performed using a single computation using arbitrarily-chosen parameters of the wellbore. This may result in the risk analysis being inaccurate and/or not representative of the actual risks associated with the wellbore.

### SUMMARY

In some aspects, the techniques described herein relate to a method for drilling planning. The method includes providing, on a graphical user interface (GUI) of a computing device, a selectable work icon associated with a modular work item of a wellbore plan. Based on a work icon selection of the selectable work icon, a drilling risk analysis system provides, on the GUI, a selectable event icon associated with historical events related to the modular work item associated with the selectable work icon. Based on an event icon selection of the selectable event icon, the drilling risk analysis system applies a risk model to the modular work item. The risk model performs a risk analysis of an event likelihood and event severity of an event related to the historical events. The risk model generates a risk analysis report of the event. The drilling risk analysis system presents the risk analysis report of the event on the GUI.

In some aspects, the techniques described herein relate to a method for drilling planning. The method includes receiving a selection of a wellbore plan. For the wellbore plan, a drilling risk analysis system receives a selection of at least one event of a plurality of events. The drilling risk analysis system receives drilling data for a plurality of offset wellbores. The drilling data includes at least one of daily drilling reports, drilling equipment information, well construction services reports, or incident information. The drilling risk analysis system receives event data for the plurality of events from the plurality of offset wellbores. Based on the selection and the event data, the drilling risk analysis system applies a risk model to the wellbore plan. The risk model performs a risk analysis of an event likelihood and event severity of the at least one event. The risk model generates a risk analysis report of the at least one event. The drilling risk analysis system presents the risk analysis report on a display of a computing device.

This summary is provided to introduce a selection of concepts that are further described in the detailed description. This summary is not intended to identify key or essential features of the claimed subject matter, nor is it intended to be used as an aid in limiting the scope of the claimed subject matter. Additional features and aspects of embodiments of the disclosure will be set forth herein, and in part will be obvious from the description, or may be learned by the practice of such embodiments.

### BRIEF DESCRIPTION OF THE DRAWINGS

In order to describe the manner in which the above-recited and other features of the disclosure may be obtained, a more particular description will be rendered by reference to specific embodiments thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example embodiments, the embodiments will be described and explained with additional specificity and detail through the use of the accompanying drawings in which:

FIG. 1 is a schematic representation of a drilling system, according to at least one embodiment of the present disclosure.

FIG. 2 is a schematic representation of a drilling risk analysis system, according to at least one embodiment of the present disclosure.

FIG. 3 is a schematic representation of a drilling risk analysis system, according to at least one embodiment of the present disclosure.

FIG. 4-1 through FIG. 4-6 are representations of a various screens or instances of a graphical user interface (GUI) of a drilling risk analysis system, according to at least one embodiment of the present disclosure.

FIG. 5 is a flowchart of a method for drilling planning, according to at least one embodiment of the present disclosure.

FIG. 6 is a flowchart of a method for drilling planning, according to at least one embodiment of the present disclosure.

FIG. 7 illustrates certain components that may be included within a computer system, according to at least one embodiment of the present disclosure.

### DETAILED DESCRIPTION

This disclosure generally relates to devices, systems, and methods for risk analysis in drilling planning. While planning a wellbore, an operator may prepare a well plan. The well plan may include a plan for a wellbore, including one or more modular work items. The modular work items may include a discrete task or set of tasks during construction of the wellbore. During construction of the wellbore, the drilling operator may experience one or more lost-time events that may result in non-productive time (NPT). Such lost-time events may cause delay to the completion of the wellbore, increased costs due to idle equipment, idle labor, mitigation costs, any other increased costs, and combinations thereof.

During wellbore planning, uncertainty in the occurrence and/or severity of an event may make it difficult to plan the wellbore. Conventionally, wellbore risk analysis systems may analyze all the risks of the entire wellbore. Such analyses may result in inaccurate estimation of operational costs. For example, a conventional wellbore risk analysis system may analyze the risks for the entire wellbore, without considering the equipment and/or drilling conditions of the wellbore. This may result in inaccurate wellbore plans.

In accordance with at least one embodiment of the present disclosure, a drilling risk analysis system allows an operator to tailor the risk analysis to the wellbore plan. For example, the drilling risk analysis system may allow the operator to select the portions of the wellbore on which to perform a risk analysis. In some examples, the drilling risk analysis system may allow the operator to identify which offset wellbore information and/or historical events to use. In some examples, the drilling risk analysis system may allow the operator to identify for which events to prepare a risk analysis. In this manner, the drilling risk analysis system may generate a risk analysis that is tailored to the particular well plan, including the drilling equipment, drilling conditions, wellbore size, and other drilling information. This may help to increase the representativeness and/or accuracy of the risk analysis.

In accordance with at least one embodiment of the present disclosure, the drilling risk analysis system may include a Monte Carlo simulation to simulate the risk severity of the event. The Monte Carlo simulation may utilize statistical variations in the variables associated with a particular event. The drilling risk analysis system may utilize the results of the Monte Carlo simulation to identify the risk associated with the particular modular work item of the wellbore. The resulting risk analysis may be more accurate and/or more representative of the actual risk associated with drilling the wellbore.

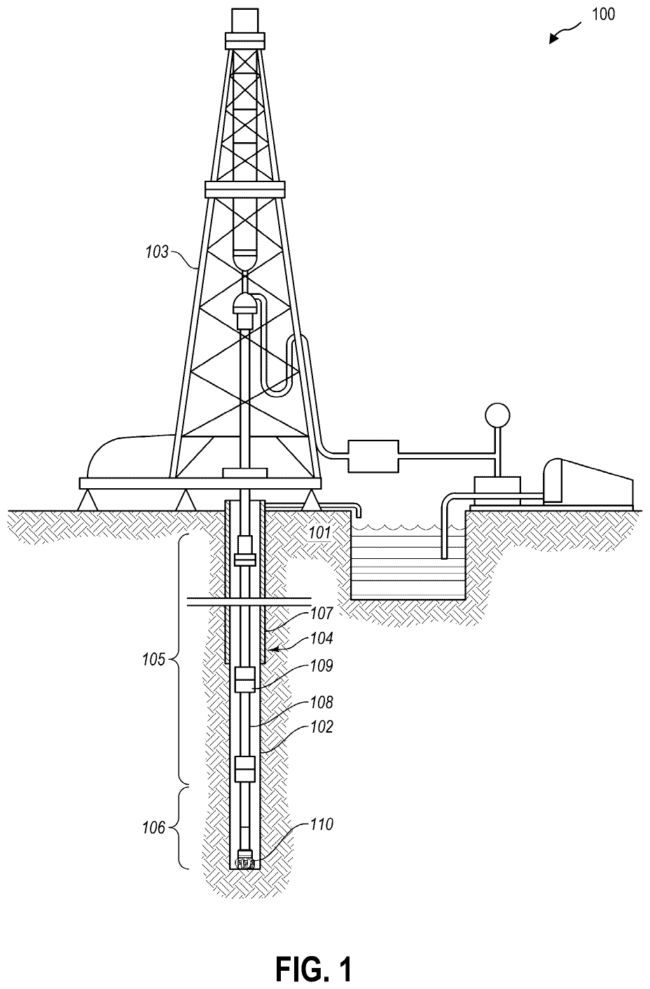

FIG. 1 shows one example of a drilling system 100 for drilling an earth formation 101 to form a wellbore 102. The drilling system 100 includes a drill rig 103 used to turn a drilling tool assembly 104 which extends downward into the wellbore 102. The drilling tool assembly 104 may include a drill string 105, a bottomhole assembly (“BHA”) 106, and a bit 110, attached to the downhole end of drill string 105.

The drill string 105 may include several joints of drill pipe 108 connected end-to-end through tool joints 109. The drill string 105 transmits drilling fluid through a central bore and transmits rotational power from the drill rig 103 to the BHA 106. In some embodiments, the drill string 105 may further include additional components such as subs, pup joints, etc. The drill pipe 108 provides a hydraulic passage through which drilling fluid is pumped from the surface. The drilling fluid discharges through selected-size nozzles, jets, or other orifices in the bit 110 for the purposes of cooling the bit 110 and cutting structures thereon, and for lifting cuttings out of the wellbore 102 as it is being drilled.

The BHA 106 may include the bit 110 or other components. An example BHA 106 may include additional or other components (e.g., coupled between to the drill string 105 and the bit 110). Examples of additional BHA components include drill collars, stabilizers, measurement-while-drilling (“MWD”) tools, logging-while-drilling (“LWD”) tools, downhole motors, underreamers, section mills, hydraulic disconnects, jars, vibration or dampening tools, other components, or combinations of the foregoing. The BHA 106 may further include a rotary steerable system (RSS). The RSS may include directional drilling tools that change a direction of the bit 110, and thereby the trajectory of the wellbore. At least a portion of the RSS may maintain a geostationary position relative to an absolute reference frame, such as gravity, magnetic north, and/or true north. Using measurements obtained with the geostationary position, the RSS may locate the bit 110, change the course of the bit 110, and direct the directional drilling tools on a projected trajectory.

In general, the drilling system 100 may include other drilling components and accessories, such as special valves (e.g., kelly cocks, blowout preventers, and safety valves). Additional components included in the drilling system 100 may be considered a part of the drilling tool assembly 104, the drill string 105, or a part of the BHA 106 depending on their locations in the drilling system 100.

The bit 110 in the BHA 106 may be any type of bit suitable for degrading downhole materials. For instance, the bit 110 may be a drill bit suitable for drilling the earth formation 101. Example types of drill bits used for drilling earth formations are fixed-cutter or drag bits. In other embodiments, the bit 110 may be a mill used for removing metal, composite, elastomer, other materials downhole, or combinations thereof. For instance, the bit 110 may be used with a whipstock to mill into casing 107 lining the wellbore 102. The bit 110 may also be a junk mill used to mill away tools, plugs, cement, other materials within the wellbore 102, or combinations thereof. Swarf or other cuttings formed by use of a mill may be lifted to surface, or may be allowed to fall downhole.

In accordance with at least one embodiment of the present disclosure, the wellbore 102 is a planned wellbore (e.g., having a planned diameter, depth, dogleg severity, and so forth), with the elements of the BHA 106 a planned BHA 106 (e.g., having planned BHA elements), the earth formation 101 a forecast earth formation 101 (e.g., based on geologic exploration and/or offset wellbores), the drill rig 103 a planned drill rig 103 (e.g., having planned drill rig equipment), the drilling tool assembly 104 a planned drilling tool assembly (e.g., having planned drilling tool elements and/or geometry), the casing 107 a planned casing (e.g., having a planned diameter, material, depth, and so forth), and the drill pipe 108 a planned drill pipe (e.g., having a planned diameter, weight per linear foot, material). Put another way, the drilling system 100 may be a planned drilling system based on a particular drilling plan.

In the planned drilling system, the operator may not know if, when, and/or for how long a lost-time event (e.g., an event resulting in non-productive time (NPT)) will occur. In some cases, examples of lost-time events are associated with cementing, such as one or more of a cement plug failure, stuck drillpipe, stuck tool, mixing slurry, mixing spacer, poor cement bond/isolation, under displacement, or over displacement. In some cases, lost-time events are related to civil works, such as issues associated with excavation, location, pits, roads, or surveying. In some embodiments, lost-time events may be associated with client or third-party complaints. Lost-time events may arise based on data quality issues, such as corrupt data, incorrect classification, incorrect data, incorrect delivery, incorrect filing, or real-time transmission.

In some cases, lost-time events may be based on deferred production and/or deferred injection of oil, gas, and/or water. One or more lost-time events may be based on equipment failure such as failure associated with one or more of a bit, casing, tubing string, casing accessories, casing drilling, casing repair, casing patching, circulation sub/WCMD, completion accessories, coiled tubing (CT) BHA, completion accessories, CT fishing, CT milling BHA, cut and pull casing equipment, downhole valves (formation isolation valve, downhole safety valve, injection control device, injection control valve), drilling motors, rotary steerable system, drillstem testing/tubing-conveyed perforating string, electrical-submersible pump related, fishing tools, gas lift, hole opener, underreamer, hydraulic pump, logging tools, milling BHA, multi-lateral equipment, MWD, LWD, completion packers, service packers, Progressing cavity pump related, perforating, plugs, retainers, sand control, service tools, setting tools, slickline tools, sucker rod pump tools, swabbing, swabbing tools, whipstock, wireline perforations, or wireline trackers.

In some embodiments, the lost-time events may be based on downhole equipment liner hangers, or downhole equipment mechanical integrity. In some embodiments, one or more lost-time events may be based on well trajectory deviations, such as based on accidental sidetrack, failure to achieve required dog-leg severity, failure to maintain verticality, failure to achieve proper separation, or missed geological target. In some embodiments, lost-time events may result from fluid issues, such as those associated with bit balling, completion fluid, drilling fluid, other chemicals, or stimulation fluid. One or more lost-time events may be based on hole problems, such as from bridging, casing collapse, tubing collapse, caving, loss of circulation, sloughing, tight hole, unable to run casing to bottom, unable to run stub length to bottom, unable to run wireline to bottom.

In some examples, lost-time events may be based on information systems malfunction or software malfunction. Lost-time events may be caused by equipment loss in hole, such as based on junk in hole, BHA loss in hole, CT BHA loss in hole, or wireline BHA loss in hole. In various cases, lost-time events may be based on production facility equipment failure, such as that associated with an alarm, berm failure, containment failure, chemical pump failure, compressor failure, conditioning fluid failure, solids control failure, electrical system failure (e.g., AC/DC system failure), emergency/overflow fluid pits, engine failure, flowlines failure, equipment handling failure, high-pressure pipework failure, instrumentation & controls failure, lifting failure, oil and gas metering, motor failure, production manifold failure, pump failure, relief/pressure safety valve failure, separator failure, storage/tankage failure, telecommunication failure, utilities failure, variable speed drive failure, or well location failure.

In various examples, lost-time events may be related to rig equipment, such as AUX pumps, BOP/well control, casing tong, compressors, conditioning fluids/solids control, derrick and hoisting, draw works and transmission, drilling location, electrical systems, engines and related components, flowlines and related components, handling, high-pressure pipework, hydraulic jacks (hydraulic workover unit), jacking systems, lifting, monitoring, motor, mud pumps, pipe handler (PH) catwalk, PH elevators, PH hydraulic roughneck, PH lower stability arm, PH pipe racker, PH powerslips, PH setback guide arm, PH tubular delivery arm, pump, other PH components, rig control systems, rig mudlogging systems, risers, remotely operated vehicles, separators, skidding, mooring, towing, snubbing/stripping equipment, storage/tankage, thruster, top drive/power swivel, or utilities.

One or more lost-time events may be associated with stuck pipe and/or tools. In some cases, lost-time events may correspond with surface equipment, such as BHA handling, BHA programming, casing/tubing running equipment, cementing equipment, coil tubing equipment, drill stem testing or tubing-conveyed perforating, fracturing equipment, instrumentation and control, logging related, managed pressure drilling equipment, mudlogging equipment, perforating equipment, pumping equipment, slickline equipment, stimulation equipment, testing equipment, waste management equipment, well head/Xmas tree isolation tool, wellhead/Xmas tree, wireline equipment, or third party equipment. In some cases, lost-time events may arise based on instructions to delay, such as client instructions, community disruption, equipment delays, force majeure, location/access, materials/water, permits, personnel, programs, regulatory decision, internal decisions, or weather. In some cases, lost-time events may be associated with well control such as based on annular pressure, kick/influx, loss of barrier integrity, surface blowout, underground blowout. The example lost-time events described herein are merely examples of some potential lost-time events and/or causes of lost-time events, and any other lost-time events (and/or combinations thereof with the foregoing) are contemplated by the present disclosure.

In some situations, in the planned drilling system, the operator may not know the severity of a particular lost-time event. For example, the operator may not know how much NPT may result from a lost-time event. Indeed, conventional techniques to determine the risk occurrence and risk severity may analyze all (or some) available information, which may reduce the accuracy and/or representation of the risk analysis.

In accordance with at least one embodiment of the present disclosure, a drilling risk analysis system may allow an operator to identify a wellbore plan and/or a particular portion of a wellbore plan for a risk assessment and/or a particular event for the risk assessment. In some embodiments, the wellbore plan may include a wellbore plan for an existing wellbore. In some embodiments, the wellbore plan may include a wellbore plan for a new wellbore. A drilling risk analysis system may receive drilling information from one or more offset wellbores. For example, the drilling risk analysis system may receive drilling information for one or more offset wellbores that share at least one common feature as the planned wellbore. This may allow the drilling risk analysis system to prepare a risk analysis based on similar wellbore features and properties.

Offset wellbore information may include any information associated with an offset wellbore. For instance, offset wellbore information may include information collected from daily drilling reports, such as drilling parameters (e.g., rotations per minute (RPM), rate of penetration (ROP), drilling fluid pressure/flow rate, weight-on-bit (WOB)). In some cases, offset wellbore information includes crew information, equipment used, maintenance reports, wellbore ID, any other daily drilling reports, and combinations thereof. The offset wellbore information may include information related to the drilling equipment used, including bit type, instrumentation, BHA equipment list, surface equipment list, drill pipe used, any other drilling equipment information, and combinations thereof. In some embodiments, the offset wellbore information may include well construction information. For example, the offset wellbore information may include information related to well construction information, such as casing installation, casing material, casing depth, fracking information, plugging information, any other well construction information, and combinations thereof. The offset wellbore information may include incident information. For example, the incident information may include information related to identifiable incidents, including lost-time events, near-misses, injury information, any other incidents, and combinations thereof.

In some cases, a wellbore plan may be separated into multiple modular work items. For example, a modular work item may be representative of a drilling task. Examples of modular work items (e.g., drilling tasks) include drilling a vertical segment of the wellbore at various hole depths, drilling a horizontal segment of the wellbore at various depths below the surface and/or various hole depths, drilling a dogleg of various dogleg severities, drilling through various formations, drilling with various equipment combinations, drilling under various drilling parameters, any other modular work item (or task), and combinations thereof. Modular work items may include any combination of modular elements.

In some cases, the drilling risk analysis system may implement a graphical user interface (GUI). For instance, in the GUI, a drilling operator planning a wellbore may select a modular work item. In some cases, the drilling operator may select modular portions of a work item, such as wellbore segment, wellbore depth, formation, equipment, and so forth. The GUI may further allow the user to select an event type on which to perform a risk analysis. Using the selected modular work item and event type, the drilling risk analysis system may perform a risk analysis.

In some embodiments, the drilling risk analysis system analyzes one or more modular work items of a wellbore plan. The risk analysis performed by the drilling risk analysis system may include a risk analysis of the event likelihood and event severity. The risk analysis of the event likelihood may be an analysis based on the likelihood that the event will occur. In some embodiments, the drilling risk analysis system may determine the event likelihood based on the offset wellbore data. Using multiple offset wellbores, some of which experienced the identified event, the drilling risk analysis system may identify the event likelihood of the event.

The event severity may include an analysis of the severity of the event. For example, the event severity may include an analysis of the amount of lost time (e.g., NPT) associated with the event. In accordance with at least one embodiment of the present disclosure, the drilling risk analysis system may estimate the event severity based on and/or using a Monte Carlo simulation. A Monte Carlo simulation is a computational algorithm that iteratively analyses an event by randomly changing the variables used to calculate the probably of that event occurring. Each iteration may randomly change the value of one or more of the variables. The Monte Carlo simulation may include hundreds, thousands, tens of thousands, hundreds of thousands, or more iterations. The resulting iterations may be combined to determine the probabilistic likelihood of the event severity.

As a specific, non-limiting example, the Monte Carlo simulation may be used to simulate the event severity of a stuck drill string in a dogleg of a wellbore. The event severity may be based on variables, including the wellbore diameter, the dogleg severity (DLS), the WOB, RPM, drilling fluid flow rate, and drilling fluid pressure. Each of the variables may include a variation range, which may include the range of values that the variable may experience. Further, each of the variables may include a variation likelihood, or the estimated likelihood that the variable may vary from the average. The variation range and variation likelihood may be determined in any manner. For example, the variation range and variation likelihood may be determined based on the offset wellbore data, including the variation range experienced across the offset wellbores. In some examples, the variation range and variation likelihood may be manually input by the operator. The severity of the stuck drill string may be calculated based on the associated variables.

As discussed herein, the Monte Carlo simulation may calculate multiple iterations of stuck drill string severity. Each iteration may be calculated using the randomly determined variable values. Over multiple iterations, the Monte Carlo simulation may generate a composite stuck drill string severity. This composite stuck drill string severity may be more accurate and/or representative of the actual severity of a stuck drill string event.

In accordance with at least one embodiment of the present disclosure, when the drilling operator is preparing a wellbore plan, the drilling operator may use the composite stuck drill string severity to prepare an estimate of the amount of NPT that may be caused by a stuck drill string. In this manner, the drilling operator may more accurately predict the NPT and associated costs of drilling a wellbore.

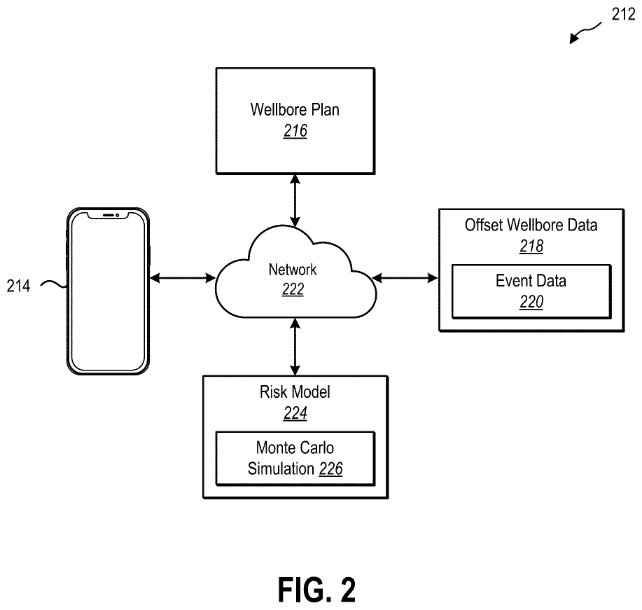

FIG. 2 is a schematic representation of a drilling risk analysis system 212, according to at least one embodiment of the present disclosure. The drilling risk analysis system 212 may include a user device 214. The user device 214 may be any type of computing device, such as a mobile device (e.g., smartphone, tablet), laptop computer, desktop computer, server computer, any other computing device, and combinations thereof. The user device 214 may receive drilling information. For example, the user device 214 may receive a wellbore plan 216, offset wellbore data 218, event data 220, any other drilling data, and combinations thereof.

The wellbore plan 216 may be developed and/or located at any location. For example, the wellbore plan 216 may be developed and/or located on the user device 214. In some examples, the wellbore plan 216 may be developed and/or located on a different computing device. In some examples, the wellbore plan 216 may be received over a network 222, such as the Internet, a local area network (LAN), wide area network (WAN), Wi-Fi network, Bluetooth connection, any other network 222, and combinations thereof.

The wellbore data 218 and/or the event data 220 may be stored and/or received from any location. For example, the wellbore data 218 and/or the event data 220 may be stored on a remote computing device, a cloud-storage device, a server device, the user device 214, any other computing device, and combinations thereof. The wellbore data 218 and/or the event data 220 may be sent to and/or accessed by the user device 214 over the network 222.

The user device 214 may analyze the risk of the wellbore plan 216 and/or certain modular work items in the wellbore plan 216 by applying a risk model 224 to the wellbore plan 216, the wellbore data 218, and the event data 220. As discussed herein, the risk model 224 may include a Monte Carlo simulation 226. The operator may interact with a GUI on the user device 214 and request the risk model 224 to perform a risk analysis on one or more modular work items from the wellbore plan 216. As discussed herein, the risk model 224 may determine the event likelihood and event severity of the event. For example, the risk model 224 may apply the Monte Carlo simulation 226 to the wellbore plan 216, the wellbore data 218, and the event data 220. The drilling operator may then use the risk analysis to prepare the cost and time estimate to drill the wellbore. This may result in an increased accuracy and/or representation of the resulting cost and time estimate.

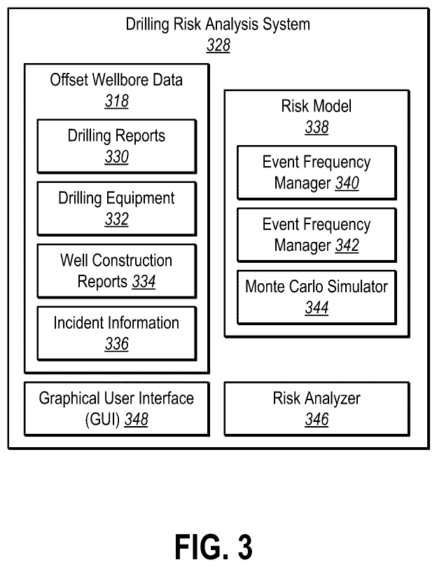

FIG. 3 is a schematic representation of a drilling risk analysis system 328, according to at least one embodiment of the present disclosure. Each of the components of the drilling risk analysis system 328 may include software, hardware, or both. For example, the components may include one or more instructions stored on a computer-readable storage medium and executable by processors of one or more computing devices, such as a client device or server device. When executed by the one or more processors, the computer-executable instructions of the drilling risk analysis system 328 may cause the computing device(s) to perform the methods described herein. Alternatively, the components may include hardware, such as a special-purpose processing device to perform a certain function or group of functions. Alternatively, the components of the drilling risk analysis system 328 may include a combination of computer-executable instructions and hardware.

Furthermore, the components of the drilling risk analysis system 328 may, for example, be implemented as one or more operating systems, as one or more stand-alone applications, as one or more modules of an application, as one or more plug-ins, as one or more library functions or functions that may be called by other applications, and/or as a cloud-computing model (and combinations thereof). Thus, the components may be implemented as a stand-alone application, such as a desktop or mobile application. Furthermore, the components may be implemented as one or more web-based applications hosted on a remote server. The components may also be implemented in a suite of mobile device applications or “apps.”

The drilling risk analysis system 328 may receive a request to prepare a risk analysis of a modular work item of a drilling plan. The drilling risk analysis system 328 may prepare the risk analysis using one or more elements. For example, the drilling risk analysis system 328 may utilize offset wellbore data 318 from one or more offset wellbores. The offset wellbore data 318 may include drilling reports 330, drilling equipment 332, well construction reports 334, incident information 336 of historical events, any other offset wellbore data 318, and combinations thereof.

As discussed herein, the drilling reports 330 may include operational reports generated during drilling operations. The drilling reports 330 may include any operational information, as discussed herein. In some embodiments, the drilling reports 330 includes time-series data. For example, the operational reports may include time-stamped information related to the drilling operations. This may allow the drilling risk analysis system 328 to identify trends over time and their impacts on the various events.

The drilling equipment 332 may include a record of the drilling equipment used, including equipment specifications, equipment parameters, maintenance records, any other drilling equipment information, and combinations thereof. The drilling equipment used may impact the event likelihood and/or event severity of an event. The drilling risk analysis system 328 may incorporate the specific equipment into the risk analysis.

The well construction reports 334 may include information related to well construction activities. For example, the well construction reports 334 may include well construction project type, well construction equipment, well construction material type, well construction material volumes, well construction crews, well construction project duration, any other well construction information, and combinations thereof. The well construction reports 334 may be used in the risk analysis of a particular well construction modular work item and/or a modular work item that operates on or around the well construction project. For example, the well casing material type and/or amount may impact the duration of a stuck drill pipe in a cased section of a wellbore.

The incident information 336 may include historical event information related to the event description, event location (e.g., basin information, depth information, formation information), event cost, event severity, any other incident information 336, and combinations thereof. The drilling risk analysis system 328 may use the incident information 336 to determine the event likelihood and/or the event severity. In some embodiments, the drilling risk analysis system 328 may analyze a particular modular work item for a particular event type.

The drilling risk analysis system 328 includes a risk model 338. The drilling risk analysis system 328 may apply the risk model 338 to the modular work item based on the offset wellbore data 318 to generate a risk analysis for the modular work item. The risk model 338 may include an event frequency manger 340. The event frequency manger 340 may determine the event likelihood of the event based on a frequency of the event occurrence (e.g., across the offset wellbores). For example, the event frequency manger 340 may analyze the frequency of the event occurrence in the incident information 336 of the offset wellbore data 318.

The drilling risk analysis system 328 further includes an event severity manager 342. The event severity manager 342 may determine the event severity of the identified event. For example, the event severity manager 342 may determine the event severity using the offset wellbore data 318. In some embodiments, the event severity manager 342 may determine the event severity using a Monte Carlo simulator 344. As discussed herein, the Monte Carlo simulator 344 may generate a probabilistic determination of the severity of the event by determining the event severity iteratively with randomized values of the various input parameters.

The drilling risk analysis system 328 may include a risk analyzer 346. The analyzer 346 may prepare a risk analysis of the event likelihood and the event severity. The risk analysis may include a summary of the event likelihood and the NPT associated with the event severity. In some embodiments, the analyzer 346 generates an event cost. The event cost may be the cost of the event based on the likelihood of the event, the NPT associated with the event severity, and the cost or consequence of the lost time from the NPT. This event cost may be used while generating a cost estimate of the wellbore plan. In this manner, the wellbore plan may be more accurate and/or representative of the actual cost (e.g., opportunity value) of performing the modular work item.

As discussed herein, the drilling risk analysis system 328 may generate the risk analysis for a single modular work item. In some embodiments, the drilling risk analysis system 328 generates the risk analysis for multiple modular work items. Generating the risk analysis for multiple modular work items may allow the operator to determine the cost estimate for an entire wellbore plan, a portion of a wellbore plan, or a wellbore plan for a portion of a wellbore.

The drilling risk analysis system 328 may further include a GUI 348. The GUI 348 may be an interactive user interface in which the operator may tailor the risk analysis to the modular work item. As discussed in further detail herein, the GUI 348 may present to the user one or more selectable icons. Based on the selection of the selectable icons, the user may identify a modular work item to analyze. The user may further identify an event type to analyze. In this manner, the user may customize the risk analysis based on the particular modular work item and/or the particular event to be analyzed. This may help to improve the accuracy and/or representation of the risk analysis.

FIG. 4-1 through FIG. 4-6 are representations of various graphical user interfaces (GUIs) 448-1, 448-2, 448-3, 448-4, 448-5, and 448-6, or instances of a GUI (collectively 448) of a drilling risk analysis system, according to at least one embodiment of the present disclosure. In the GUIs 448, the interface may provide or present to the user one or more selectable icons. The selectable icons may be provided in any manner, such as a word, an image, an illustration, a video, a GIF, any other type of selectable icon, and combinations thereof. The user may interact with the GUI 448 to select a selectable icon. Upon selection of a selectable icon, the GUI 448 may be modified to present additional information to the user. For example, upon selection of a selectable icon, the GUI 448 may provide the user with a new window, an overlapping window, a menu, additional selectable icons, open an application, open a webpage on the internet, any other action, and combinations thereof.

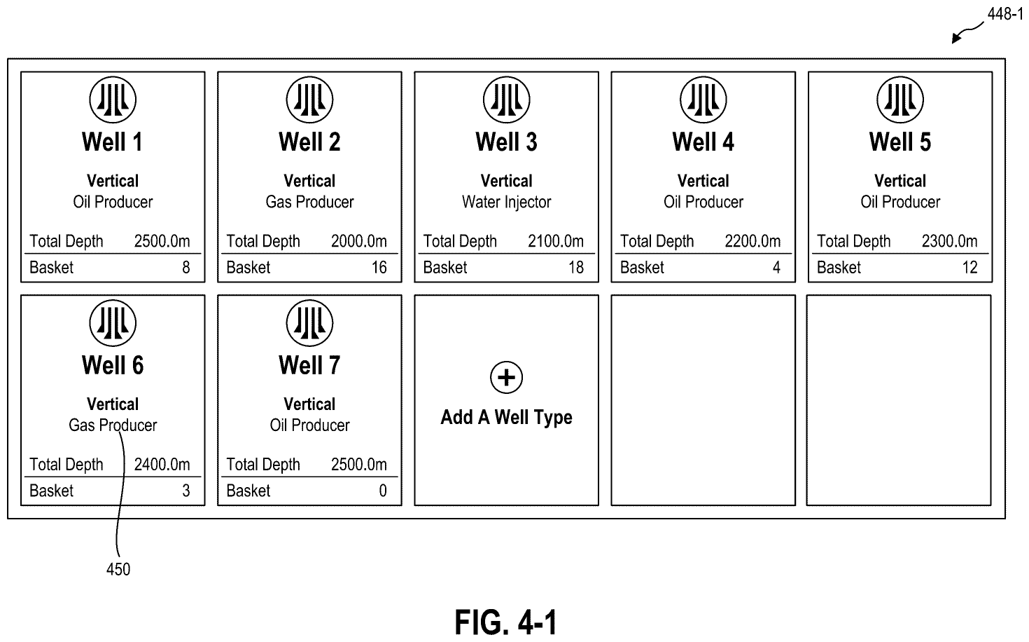

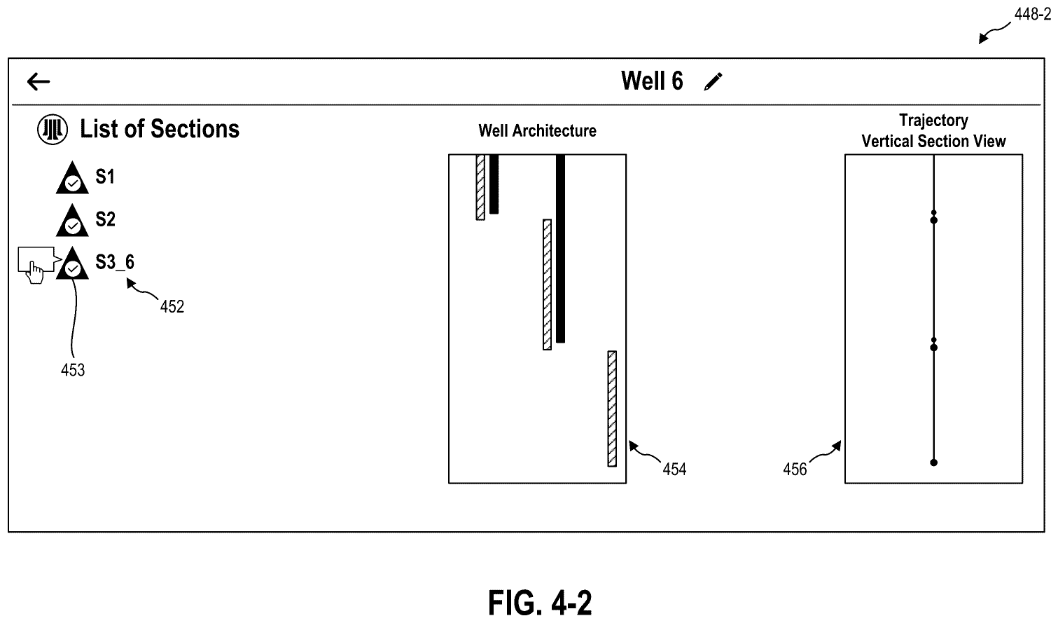

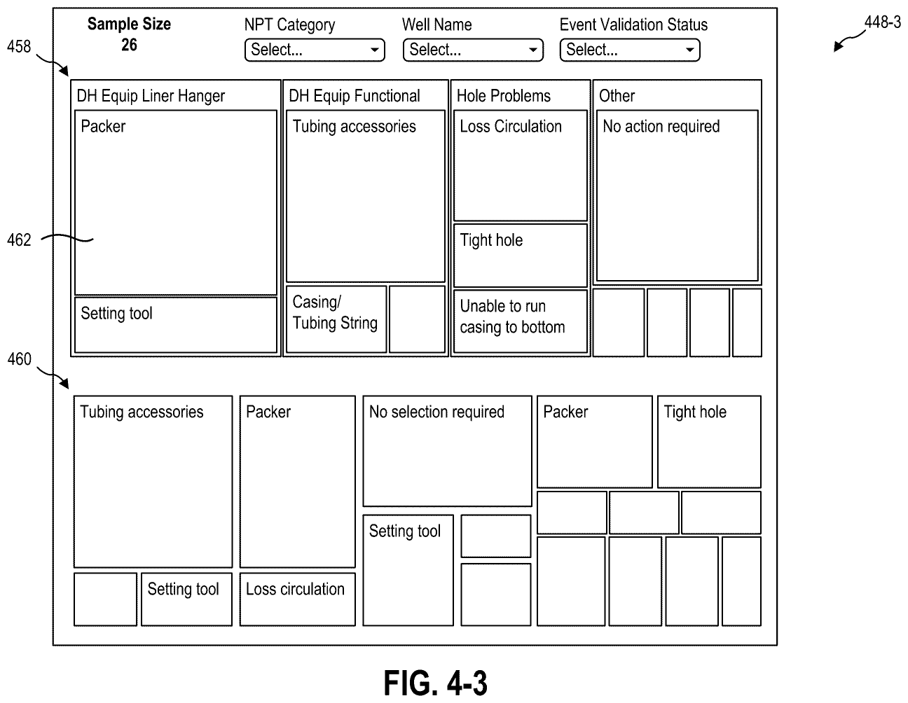

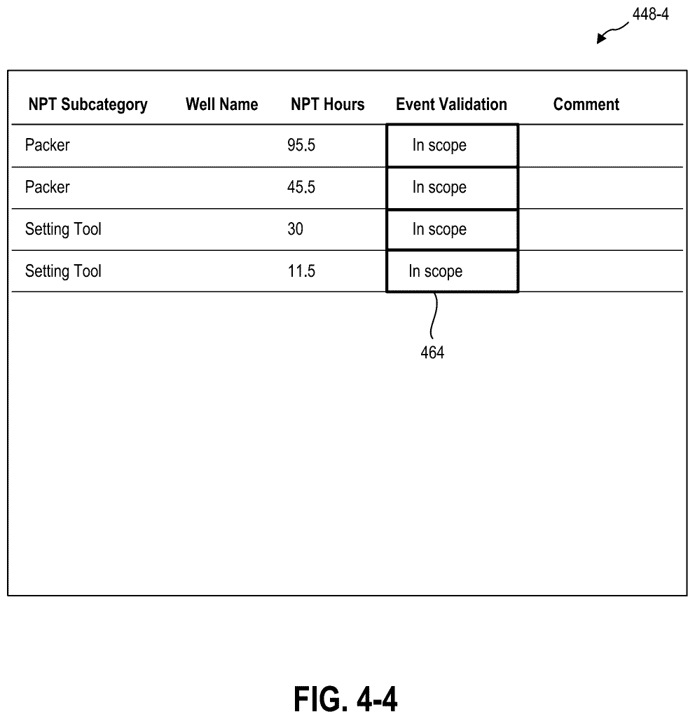

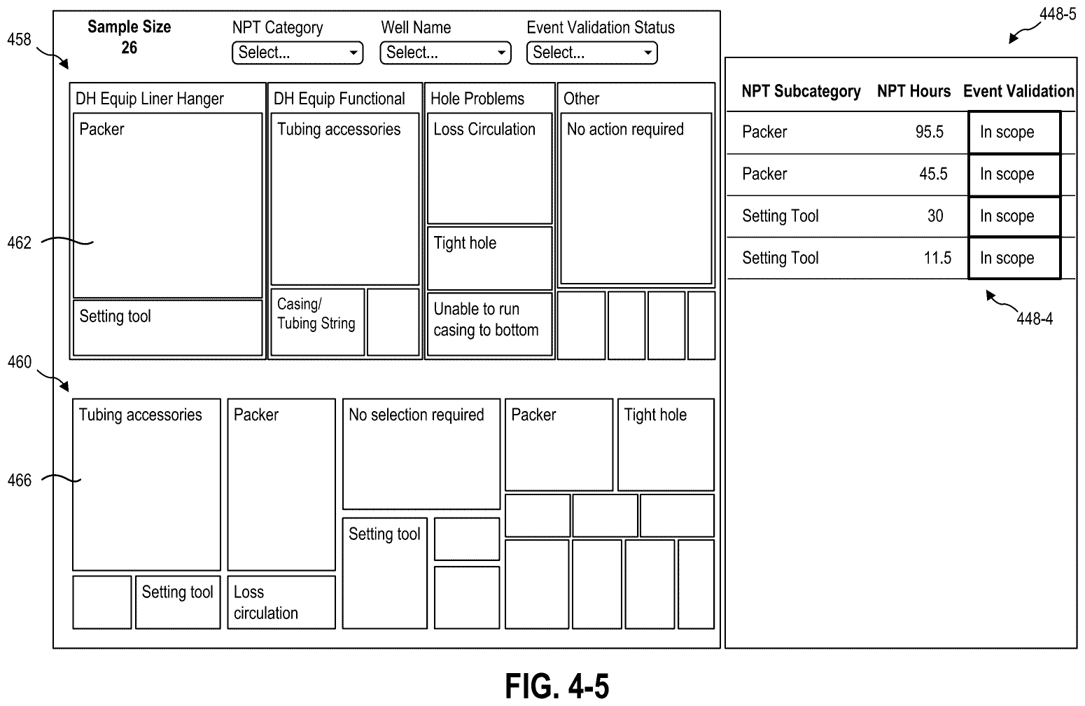

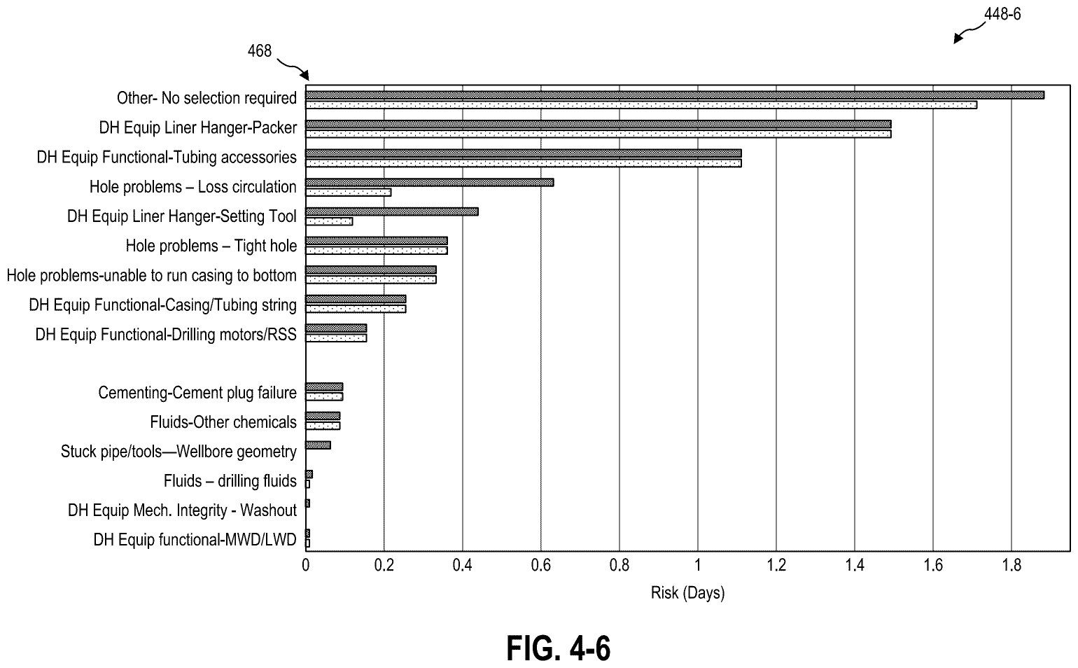

In the embodiment shown in FIG. 4-1, a first GUI 448-1 provides or presents to the user a plurality of selectable wellbore icons 450. The selectable wellbore icons 450 may be representative of one or more wellbore plans. The selectable wellbore icons 450 may include identifying information related to the wellbore plan, such as a wellbore name, wellbore location, wellbore descriptors, wellbore depth, any other identifying information, and combinations thereof. The user may review the identifying information on the selectable wellbore icons 450 and identify which of the wellbore plans for which to prepare a risk analysis.

The user may then select one of the selectable wellbore icons 450. The selection may occur in any manner. For example, the user may control a “pointer” on the GUI 448 by an input device, such as a mouse, a track pad, or other input device. The user may indicate the input by clicking on a button of the input device when the pointer overlays the desired selectable icon. In some examples, the user may touch a touch-sensitive display on the selectable icon to select the selectable icon. In some examples, the user may manipulate a keyboard to select the selectable icon. In some examples, the user may select the icon in any other manner to select the selectable icon.

When the user selects a selectable wellbore icon 450, the risk analysis system may present a second GUI 448-2, as illustrated in FIG. 4-2. The second GUI 448-2 may include wellbore plan information about the wellbore plan selected with the selectable wellbore icon 450. The wellbore plan information may include any wellbore plan information, such as a list of modular work items 452, a graphical well architecture 454, a wellbore trajectory 456, any other wellbore plan information, and combinations thereof. Each of the elements of the wellbore plan information may include a selectable icon. For example, the list of modular work items 452 may include selectable work icons 453. When the user selects one of the selectable work icons 453, the second GUI 448-2 may present additional detail regarding the selectable work icon. In some embodiments, when the user selects one of the selectable work icons 453, the second GUI 448-2 adjusts the graphical well architecture 454 and/or the wellbore trajectory 456 to display additional details regarding the modular work item 452 associated with the selectable work icon 453.

When the user selects a selectable work icon 453 associated with a modular work item, the risk analysis system may present or provide to the user a third GUI 448-3, as illustrated in FIG. 4-3. The third GUI 448-3 may identify one or more event types 458 and offset wellbores 460. Each of the event types 458 may include a selectable event icon 462. The selectable event icon 462 may allow the user to select a particular event for the modular work item. Upon selection of the selectable event icon 462, the drilling risk analysis system may prepare a risk analysis of the modular work item for the identified event.

Upon selection of the selectable event icon 462, the third GUI 448-3 may prepare a fourth GUI 448-4, as illustrated in FIG. 4-4. The fourth GUI 448-4 may provide additional event information, including sub-categories of the event, event causes, and so forth. The fourth GUI 448-4 may include an event details icon 464. Using the fourth GUI 448-4, the user may select and/or un-select which of the event details to consider in the risk analysis. For example, a user may identify that event details icon 464 is associated with an event sub-category. The event sub-category may be based on certain formation, equipment selection, and so forth.

The user may select and/or un-select which event details to consider based on any factor. For example, the user may select and/or un-select which event details to consider based on which party accepts risk for a particular event, equipment choices that mitigate the risk, any other consideration, and combinations thereof. When the user un-selects one of the event details icons 464, the risk analysis system may not present a risk analysis of that particular element and/or may not consider the sub-category based on the selection.

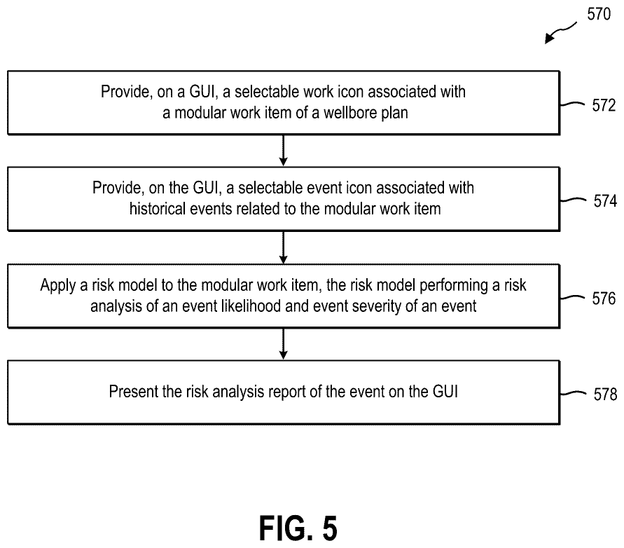

As discussed herein, one or more of the GUIs 448 may include an overlay over another GUI 448. For example, as may be seen in FIG. 4-5, the fourth GUI 448-4 may be overlaid over the third GUI 448-3, resulting in a fifth GUI 448-5. The fifth GUI 448-5 may include a representation of the selected event types 458, such as by highlighting the selected selectable event icons 462, un-highlighting the un-selected selectable event icons 462, or otherwise distinguishing the selected and un-selected selectable event icons 462.

The offset wellbores 460 may include selectable offset wellbore icons 466. The user may select one or more of the selectable offset wellbore icons 466 to determine which of the offset wellbores may be considered in the risk analysis. For example, the user may desire to and/or un-select one or more of the selectable offset wellbore icons 466 based on a relatedness of the offset wellbores, similar features, similar geology, similar equipment, any other similarity or dissimilarity, and combinations thereof.

When the user completes the selection or un-selection of the wellbore plan, the offset wellbores, the events, the event sub-categories, any other selection, and combinations thereof, the drilling risk analysis system may perform the risk analysis, as discussed herein. The drilling risk analysis system may prepare a sixth GUI 448-6 illustrating a risk analysis report 468 for the user. The risk analysis report 468 may include a visual representation of the risk analysis. For example, in the embodiment shown, the risk analysis report 468 includes a bar graph illustrating the risk severity of the analyzed events. In the view shown, each event includes an upper bar representing the un-mitigated risk and a lower bar representing the mitigated risk, such as the risk mitigated by un-selecting one or more of the selectable event icon 462 or the event details icon 464. As discussed herein, such a risk analysis may be more accurate and/or representative of the actual risks, and the risk analysis report 468 may identify areas in which the risk analysis has conventionally over-estimated the associated risks.

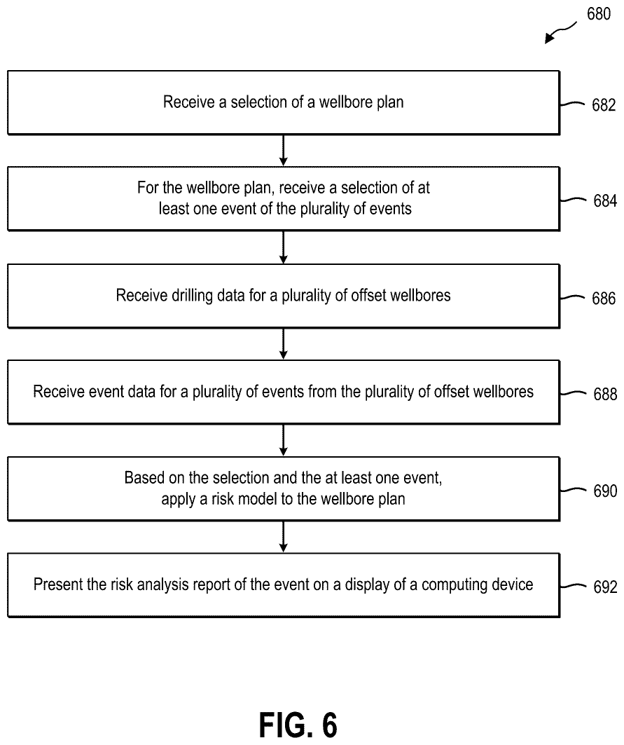

FIGS. 5 and 6, the corresponding text, and various examples provide a number of different methods, systems, devices, and computer-readable media of the drilling risk analysis system 328 as described herein. In addition to the foregoing, one or more embodiments may also be described in terms of flowcharts comprising acts for accomplishing a particular result, as shown in FIGS. 5 and 6. FIGS. 5 and 6 may be performed with more or fewer acts. Further, the acts may be performed in differing orders. Additionally, the acts described herein may be repeated or performed in parallel with one another or parallel with different instances of the same or similar acts.

As mentioned, FIG. 5 illustrates a flowchart of a series of acts or a method 570 for drilling planning, according to at least one embodiment of the present disclosure. While FIG. 5 illustrates acts according to one embodiment, alternative embodiments may omit, add to, reorder, and/or modify any of the acts shown in FIG. 5. The acts of FIG. 5 may be performed as part of a method. Alternatively, a computer-readable medium may comprise instructions that, when executed by one or more processors, cause a computing device to perform the acts of FIG. 5. In some embodiments, a system may perform the acts of FIG. 5.

The drilling risk analysis system may provide, on a GUI of a computing device, a selectable work icon associated with a modular work item of a wellbore plan at 572. Based on receiving a work icon selection of the selectable work icon, the drilling risk analysis system may provide, on the GUI, a selectable event icon associated with historical events related to the modular work item associated with the selectable work icon at 574. As discussed herein, the historical events may be based on drilling data for a plurality of offset wellbores. The drilling data may include at least one of daily drilling reports, drilling equipment information, well construction services reports, and incident information. In some embodiments, the event related to historical events includes a plurality of events. The user may make an event icon selection that includes a selection of a plurality of events. The risk model may perform the risk analysis on each of the selected plurality of events. In some embodiments, the event icon selection includes un-selecting an event icon associated with an irrelevant event of the plurality of events.

Based on receiving an event icon selection of the selectable event icon, the drilling risk analysis system may apply a risk model to the modular work icon at 576. The risk model may perform a risk analysis of an event likelihood and event severity of an event related to the historical events. The risk model may generate a risk analysis report of the event. In accordance with at least one embodiment of the present disclosure, the risk model may apply a Monte Carlo Simulation to the modular work item to generate the event severity. In some embodiments, the event severity includes an estimate of the NPT associated with the event. The drilling risk analysis system may present the risk analysis report of the event on the GUI at 578.

As mentioned, FIG. 6 illustrates a flowchart of a series of acts or a method 680 for drilling planning, according to at least one embodiment of the present disclosure. While FIG. 6 illustrates acts according to one embodiment, alternative embodiments may omit, add to, reorder, and/or modify any of the acts shown in FIG. 6. The acts of FIG. 6 may be performed as part of a method. Alternatively, a computer-readable medium may comprise instructions that, when executed by one or more processors, cause a computing device to perform the acts of FIG. 6. In some embodiments, a system may perform the acts of FIG. 6.

A drilling risk analysis system may receive a selection of a wellbore plan at 682. The drilling risk analysis system may, for the selected wellbore plan, receive a selection of at least one event of the plurality of events at 684. As discussed herein, the selection of the at least one event is an event selection, and the drilling risk analysis system may receive a wellbore selection of at least one of the plurality of offset wellbores.

The drilling risk analysis system may receive drilling data for a plurality of offset wellbores at 686. As discussed herein, the drilling data may include at least one of daily drilling reports, drilling equipment information, well construction services reports, or incident information. The drilling risk analysis system may receive event data for a plurality of events from the plurality of offset wellbores at 688.

In accordance with at least one embodiment of the present disclosure, the drilling risk analysis system, based on the selection of the event and the event data, applies a risk model to the wellbore plan at 690. The risk model performs a risk analysis of an event likelihood and event severity of the at least one event. In some embodiments, the risk model applies the risk model based at least in part on the wellbore selection. In some embodiments, applying the risk model includes not applying the risk model to an un-selected event of the plurality of events. In some embodiments, the wellbore plan includes a portion of a wellbore plan, and applying a risk model includes applying the risk model to the portion of the wellbore plan. In some embodiments, the risk model includes a Monte Carlo simulation of the risk severity. In some embodiments, the plurality of events include lost-time events, and the risk severity includes a lost-time estimate. The risk model generates a risk analysis report of the event, and the drilling risk analysis system presents the risk analysis report on a display of a computing device.

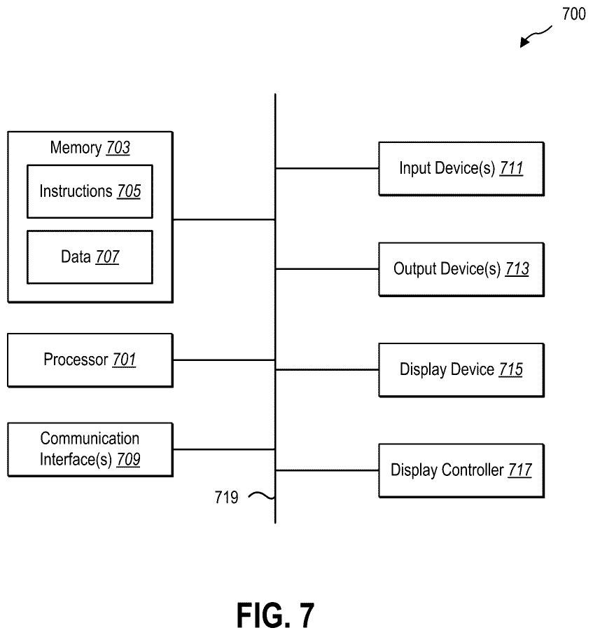

FIG. 7 illustrates certain components that may be included within a computer system 700. One or more computer systems 700 may be used to implement the various devices, components, and systems described herein.

The computer system 700 includes a processor 701. The processor 701 may be a general-purpose single or multi-chip microprocessor (e.g., an Advanced RISC (Reduced Instruction Set Computer) Machine (ARM)), a special purpose microprocessor (e.g., a digital signal processor (DSP)), a microcontroller, a programmable gate array, etc. The processor 701 may be referred to as a central processing unit (CPU). Although just a single processor 701 is shown in the computer system 700 of FIG. 7, in an alternative configuration, a combination of processors (e.g., an ARM and DSP) could be used.

The computer system 700 also includes memory 703 in electronic communication with the processor 701. The memory 703 may be any electronic component capable of storing electronic information. For example, the memory 703 may be embodied as random access memory (RAM), read-only memory (ROM), magnetic disk storage media, optical storage media, flash memory devices in RAM, on-board memory included with the processor, erasable programmable read-only memory (EPROM), electrically erasable programmable read-only memory (EEPROM), registers, and so forth, including combinations thereof.

Instructions 705 and data 707 may be stored in the memory 703. The instructions 705 may be executable by the processor 701 to implement some or all of the functionality disclosed herein. Executing the instructions 705 may involve the use of the data 707 that is stored in the memory 703. Any of the various examples of modules and components described herein may be implemented, partially or wholly, as instructions 705 stored in memory 703 and executed by the processor 701. Any of the various examples of data described herein may be among the data 707 that is stored in memory 703 and used during execution of the instructions 705 by the processor 701.

A computer system 700 may also include one or more communication interfaces 709 for communicating with other electronic devices. The communication interface(s) 709 may be based on wired communication technology, wireless communication technology, or both. Some examples of communication interfaces 709 include a Universal Serial Bus (USB), an Ethernet adapter, a wireless adapter that operates in accordance with an Institute of Electrical and Electronics Engineers (IEEE) 802.11 wireless communication protocol, a Bluetooth® wireless communication adapter, and an infrared (IR) communication port.

A computer system 700 may also include one or more input devices 711 and one or more output devices 713. Some examples of input devices 711 include a keyboard, mouse, microphone, remote control device, button, joystick, trackball, touchpad, and lightpen. Some examples of output devices 713 include a speaker and a printer. One specific type of output device that is typically included in a computer system 700 is a display device 715. Display devices 715 used with embodiments disclosed herein may utilize any suitable image projection technology, such as liquid crystal display (LCD), light-emitting diode (LED), gas plasma, electroluminescence, or the like. A display controller 717 may also be provided, for converting data 707 stored in the memory 703 into text, graphics, and/or moving images (as appropriate) shown on the display device 715.

The various components of the computer system 700 may be coupled together by one or more buses, which may include a power bus, a control signal bus, a status signal bus, a data bus, etc. For the sake of clarity, the various buses are illustrated in FIG. 7 as a bus system 719.

### INDUSTRIAL APPLICABILITY

The following description from ¶¶[0082]-[0101] includes various embodiments that, where feasible, may be combined in any permutation. For example, the embodiment of ¶[0082] may be combined with any or all embodiments of the following paragraphs. Embodiments that describe acts of a method may be combined with embodiments that describe, for example, systems and/or devices. Any permutation of the following paragraphs is considered to be hereby disclosed for the purposes of providing “unambiguously derivable support” for any claim amendment based on the following paragraphs. Furthermore, the following paragraphs provide support such that any combination of the following paragraphs would not create an “intermediate generalization.”

In some embodiments, a method for drilling planning includes providing, on a graphical user interface (GUI) of a computing device, a selectable work icon associated with a modular work item of a wellbore plan, based on receiving a work icon selection of the selectable work icon, providing, on the GUI, a selectable event icon associated with historical events related to the modular work item associated with the selectable work icon, based on receiving an event icon selection of the selectable event icon, applying a risk model to the modular work item, the risk model performing a risk analysis of an event likelihood and event severity of an event related to the historical events, the risk model generating a risk analysis report of the event, and presenting the risk analysis report of the event on the GUI.

In some embodiments, the historical events are based on drilling data for a plurality of offset wellbores, the drilling data including at least one of daily drilling reports, drilling equipment information, well construction services reports, or incident information.

In some embodiments, applying the risk model includes applying a Monte Carlo simulation to the modular work item to generate the event severity.

In some embodiments, the event severity includes an estimate of non-productive time (NPT) associated with the event.

In some embodiments, the wellbore plan includes a scope of work for a new wellbore.

in some embodiments, the event related to historical events includes a plurality of events, and wherein the event icon selection includes a selection of the plurality of events, the risk model performing the risk analysis on each of the plurality of events.

In some embodiments, the event icon selection includes un-selecting an event icon associated with an irrelevant event of the plurality of events.

In some embodiments, a method for drilling planning includes receiving a selection of a wellbore plan, for the wellbore plan, receiving a selection of at least one event of a plurality of events, receiving drilling data for a plurality of offset wellbores, the drilling data including at least one of daily drilling reports, drilling equipment information, well construction services reports, or incident information, receiving event data for the plurality of events from the plurality of offset wellbores, based on the selection and the event data, applying a risk model to the wellbore plan, the risk model performing a risk analysis of an event likelihood and event severity of the at least one event, the risk model generating a risk analysis report of the at least one event, and presenting the risk analysis report on a display of a computing device.

In some embodiments, the selection is an event selection, and further comprising receiving a wellbore selection of at least one of the plurality of offset wellbores, and wherein applying the risk model includes applying the risk model based at least in part on the wellbore selection.

In some embodiments, applying the risk model includes not applying the risk model to an un-selected event of the plurality of events.

In some embodiments, the wellbore plan includes a portion of a wellbore plan, and wherein applying a risk model includes applying the risk model to the portion of the wellbore plan.

In some embodiments, the risk model includes a Monte Carlo simulation of the event severity.

In some embodiments, the plurality of events include lost-time events, and wherein the event severity includes a lost-time estimate.

In some embodiments, a drilling planning system includes a processor and memory, the memory including instructions that cause the processor to provide, on a graphical user interface (GUI) of a computing device, a selectable work icon associated with a modular work item of a wellbore plan, based on receiving a work icon selection of the selectable work icon, provide, on the GUI, a selectable event icon associated with historical events related to the modular work item associated with the selectable work icon, based on receiving an event icon selection of the selectable event icon, apply a risk model to the modular work item, the risk model performing a risk analysis of an event likelihood and event severity of an event related to the historical events, the risk model generating a risk analysis report of the event, and present the risk analysis report of the event on the GUI.

In some embodiments, the historical events are based on drilling data for a plurality of offset wellbores, the drilling data including at least one of daily drilling reports, drilling equipment information, well construction services reports, or incident information.

In some embodiments, applying the risk model includes applying a Monte Carlo simulation to the modular work item to generate the event severity.

In some embodiments, the event severity includes an estimate of non-productive time (NPT) associated with the event.

In some embodiments, the wellbore plan includes a scope of work for a new wellbore.

In some embodiments, the event related to historical events includes a plurality of events, and wherein the event icon selection includes a selection of the plurality of events, the risk model performing the risk analysis on each of the plurality of events.

In some embodiments, the event icon selection includes un-selecting an event icon associated with an irrelevant event of the plurality of events.

The embodiments of the drilling risk analysis system have been primarily described with reference to wellbore drilling operations; the drilling risk analysis systems described herein may be used in applications other than the drilling of a wellbore. In other embodiments, drilling risk analysis systems according to the present disclosure may be used outside a wellbore or other downhole environment used for the exploration or production of natural resources. For instance, drilling risk analysis systems of the present disclosure may be used in a borehole used for placement of utility lines. Accordingly, the terms “wellbore,” “borehole” and the like should not be interpreted to limit tools, systems, assemblies, or methods of the present disclosure to any particular industry, field, or environment.

One or more specific embodiments of the present disclosure are described herein. These described embodiments are examples of the presently disclosed techniques. Additionally, in an effort to provide a concise description of these embodiments, not all features of an actual embodiment may be described in the specification. It should be appreciated that in the development of any such actual implementation, as in any engineering or design project, numerous embodiment-specific decisions will be made to achieve the developers' specific goals, such as compliance with system-related and business-related constraints, which may vary from one embodiment to another. Moreover, it should be appreciated that such a development effort might be complex and time consuming, but would nevertheless be a routine undertaking of design, fabrication, and manufacture for those of ordinary skill having the benefit of this disclosure.

Additionally, it should be understood that references to “one embodiment” or “an embodiment” of the present disclosure are not intended to be interpreted as excluding the existence of additional embodiments that also incorporate the recited features. For example, any element described in relation to an embodiment herein may be combinable with any element of any other embodiment described herein. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims.

The terms “approximately,” “about,” and “substantially” as used herein represent an amount close to the stated amount that is within standard manufacturing or process tolerances, or which still performs a desired function or achieves a desired result. For example, the terms “approximately,” “about,” and “substantially” may refer to an amount that is within less than 5% of, within less than 1% of, within less than 0.1% of, and within less than 0.01% of a stated amount. Further, it should be understood that any directions or reference frames in the preceding description are merely relative directions or movements. For example, any references to “up” and “down” or “above” or “below” are merely descriptive of the relative position or movement of the related elements.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A method for drilling planning, the method comprising:
providing, on a graphical user interface (GUI) of a computing device, a selectable work icon associated with a modular work item of a wellbore plan;
based on receiving a work icon selection of the selectable work icon, providing, on the GUI, a selectable event icon associated with historical events related to the modular work item associated with the selectable work icon;
based on receiving an event icon selection of the selectable event icon, applying a risk model to the modular work item, the risk model performing a risk analysis of an event likelihood and event severity of an event related to the historical events, the risk model generating a risk analysis report of the event; and
presenting the risk analysis report of the event on the GUI.

2. The method of claim 1, wherein the historical events are based on drilling data for a plurality of offset wellbores, the drilling data including at least one of daily drilling reports, drilling equipment information, well construction services reports, or incident information.

3. The method of claim 1, wherein applying the risk model includes applying a Monte Carlo simulation to the modular work item to generate the event severity.

4. The method of claim 1, wherein the event severity includes an estimate of non-productive time (NPT) associated with the event.

5. The method of claim 1, wherein the wellbore plan includes a scope of work for a new wellbore.

6. The method of claim 1, wherein the event related to historical events includes a plurality of events, and wherein the event icon selection includes a selection of the plurality of events, the risk model performing the risk analysis on each of the plurality of events.

7. The method of claim 6, wherein the event icon selection includes un-selecting an event icon associated with an irrelevant event of the plurality of events.

8. A method for drilling planning, the method comprising:
receiving a selection of a wellbore plan;
for the wellbore plan, receiving a selection of at least one event of a plurality of events;
receiving drilling data for a plurality of offset wellbores, the drilling data including at least one of daily drilling reports, drilling equipment information, well construction services reports, or incident information;
receiving event data for the plurality of events from the plurality of offset wellbores;
based on the selection and the event data, applying a risk model to the wellbore plan, the risk model performing a risk analysis of an event likelihood and event severity of the at least one event, the risk model generating a risk analysis report of the at least one event; and
presenting the risk analysis report on a display of a computing device.

9. The method of claim 8, wherein the selection is an event selection, and further comprising receiving a wellbore selection of at least one of the plurality of offset wellbores, and wherein applying the risk model includes applying the risk model based at least in part on the wellbore selection.

10. The method of claim 8, wherein applying the risk model includes not applying the risk model to an un-selected event of the plurality of events.

11. The method of claim 8, wherein the wellbore plan includes a portion of a wellbore plan, and wherein applying a risk model includes applying the risk model to the portion of the wellbore plan.

12. The method of claim 8, wherein the risk model includes a Monte Carlo simulation of the event severity.

13. The method of claim 8, wherein the plurality of events include lost-time events, and wherein the event severity includes a lost-time estimate.

14. A drilling planning system, comprising:
a processor and memory, the memory including instructions that cause the processor to:
provide, on a graphical user interface (GUI) of a computing device, a selectable work icon associated with a modular work item of a wellbore plan;
based on receiving a work icon selection of the selectable work icon, provide, on the GUI, a selectable event icon associated with historical events related to the modular work item associated with the selectable work icon;
based on receiving an event icon selection of the selectable event icon, apply a risk model to the modular work item, the risk model performing a risk analysis of an event likelihood and event severity of an event related to the historical events, the risk model generating a risk analysis report of the event; and
present the risk analysis report of the event on the GUI.

15. The drilling planning system of claim 14, wherein the historical events are based on drilling data for a plurality of offset wellbores, the drilling data including at least one of daily drilling reports, drilling equipment information, well construction services reports, or incident information.

16. The drilling planning system of claim 14, wherein applying the risk model includes applying a Monte Carlo simulation to the modular work item to generate the event severity.

17. The drilling planning system of claim 14, wherein the event severity includes an estimate of non-productive time (NPT) associated with the event.

18. The drilling planning system of claim 14, wherein the wellbore plan includes a scope of work for a new wellbore.

19. The drilling planning system of claim 14, wherein the event related to historical events includes a plurality of events, and wherein the event icon selection includes a selection of the plurality of events, the risk model performing the risk analysis on each of the plurality of events.

20. The drilling planning system of claim 19, wherein the event icon selection includes un-selecting an event icon associated with an irrelevant event of the plurality of events.
